(19) United States
(12) Patent Application Publication
(10) Pub. No.: US 2026/0129412 A1
(43) Pub. Date: May 7, 2026

(54) METHOD, APPARATUS AND COMPUTER PROGRAM

(71) Applicant: Nokia Solutions and Networks Oy, Espoo (FI)

(72) Inventor: Arto Kristian SUVITIE, Espoo (FI)

(21) Appl. No.: 19/279,474

(22) Filed: Jul. 24, 2025

(30) Foreign Application Priority Data
Nov. 6, 2024 (FI) 20246310

(51) Int. Cl. H04W 4/40; H04L 1/1867; H04L 69/16

(52) U.S. Cl. CPC H04W 4/40; H04L 1/189; H04L 69/16

(57) ABSTRACT

A second apparatus configured for: receiving data about an unmanned vehicle; using the data to determine a first state of the unmanned vehicle, the first state being one of a plurality of different and mutually exclusive states; sending a first message to a first apparatus, the first message comprising information about the first state; receiving further data about the unmanned vehicle, using the further data which has been collected to determine if there is a change in status associated with the unmanned vehicle, in response to determining that there is a change in status associated with the unmanned vehicle, sending a second message to the first apparatus, the second message comprising information about the change in status associated with the unmanned vehicle.

### TECHNICAL FIELD

The present disclosure relates to apparatus, methods and computer program. In particular, but not exclusively, the present disclosure relates to apparatus, methods and computer programs associated with an object capable of moving.

### BACKGROUND

Unmanned vehicles, such as aerial vehicles (e.g. unmanned aerial vehicles (UAVs), or unmanned vehicles), land vehicles and robots are vehicles that are operated without a human operator on board. UAVs are sometimes referred to as drones.

Unmanned vehicles may be used to execute a variety of different missions. For example, they may be deployed to collect data from a plurality of different areas (e.g. either from sensors on board the unmanned vehicles, or through collecting data from sensors located outside the reach of a traditional communications network), they may be used to deliver and/or collect objects, and collect/stream video data as they move.

### SUMMARY

Some example embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to a first aspect, there is provided a second apparatus comprising: means for receiving data about an object, the object being capable of moving; means for using the data which has been received to determine a first state of the object, the first state being one of a plurality of different and mutually exclusive states of the object; means for sending a first message to a first apparatus, the first message comprising information about the first state; wherein the means for receiving is for receiving further data about the object, the means for using is for using the further data which has been collected to determine if there is a change in status associated with the object, and the means for sending is for, in response to determining that there is a change in status associated with the object, sending a second message to the first apparatus, the second message comprising information about the change in status associated with the object.

Other features can be seen from the claims dependent on claim 1.

According to a second aspect of the invention, there is provided a method comprising: receiving data about an object, the object being capable of moving; using the data which has been received to determine a first state of the object, the first state being one of a plurality of different and mutually exclusive states of the object; sending a first message to a first apparatus, the first message comprising information about the first state; receiving further data about the object; using the further data which has been received to determine if there is a change in status associated with the object, and in response to determining that there is a change in status associated with the object, sending a second message to the first apparatus, the second message comprising information about the change in status associated with the object.

One of more of the plurality of different and exclusive states comprise one or more mutually exclusive substates.

The change in status associated with the object may comprise one or more of: a change from one of the plurality of different and mutually exclusive states to another one of the plurality of different and exclusive states; or a change from one of the plurality of different and mutually exclusive substates to another one of the plurality of different and mutually exclusive substates.

One or more of the first message or the second message may use a message format comprising a plurality of fields where only one of said fields is set at a given time, different ones of said fields being associated with a different status of the object capable of moving. The message format may use a protocol buffer data format.

The first and second messages may be sent to the first apparatus using an acknowledgement based protocol, such that if a respective acknowledgement is not received, the respective message is resent.

The acknowledgement based protocol may comprise a transmission control protocol.

The object may comprise one of: a vehicle; an autonomous vehicle; an airborne vehicle, a robot; or a drone.

The object may comprise a drone and the first apparatus may comprise one or more of a ground control station or a companion computing apparatus on the drone.

The companion computing apparatus may be configured to use the information from one or more of the first and second messages to provide one or more third messages for sending to the or a ground control station.

The one or more of the third messages may comprise data relating to one or more sensors carried by the drone and the information provided by a respective one of the first and second messages.

The method may comprised collecting the data about the object.

One or more of the collected data or the further collected data may comprise one or more of: system status data; heartbeat data; error data; ongoing mission data; or position data.

The plurality of different and mutually exclusive states may comprise one or more of:
landed; flying; or crashed.

The one or more substates of the landed status may comprise one or more of: armed; or disarmed.

The one or more substates of the flying status may comprise one or more of: hover; manual flight; mission flight; docking station landing; or guided flight.

The one or more substates of the crash status comprise one or more of: crash location; or crash reason.

The method may be performed by an apparatus. The apparatus may be a second apparatus.

The method may be performed by the object which comprises the second apparatus. The object may comprise the first apparatus. The object may be a drone.

The apparatus or object may comprise means for performing the method.

The apparatus or object may comprise at least one processor; and at least one memory storing instructions that, when executed by the at least one processor, cause the apparatus at least to provide one or more of the methods of the second aspect.

According to another aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 schematically illustrates a ground control station and a drone;

FIG. 2 schematically illustrates a ground control station and a drone of some embodiments;

FIG. 3 shows a procedure of some embodiments;

FIG. 4 shows some methods of some example embodiments;

FIG. 5 shows an example apparatus used by some embodiments.

### DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Some example embodiments will now be described in relation to UAVs, for example drones. However, it should be appreciated that this is by way of example only and other embodiments may be used with any other suitable object which is capable of moving. For example, other embodiments may be provided in relation to autonomous land vehicles, autonomous sea vehicles, or robots.

Some example embodiments may relate to the communication between a first apparatus and a second apparatus. The second apparatus may be provided on board the object which is capable of moving or as part of the object capable of moving. In some embodiments, the second apparatus may be remote from the object which is capable of moving. For example, the second apparatus may be provided in a control station which is remote from the object capable of moving.

The first apparatus may receive data. In the examples discussed, the data may be telemetry related data. The data may be sensor data and/or any suitable data.

The first apparatus may be a control station which is remote from the object capable of moving.

Alternatively or additionally, the first apparatus may be provided on board the object capable of moving.

By way of example only, the first apparatus on the object capable of moving may be a so-called companion computer. A companion computer may be provided on the object which is capable of moving for example to control one or more sensors and/or to collect data from one or more sensors. The sensors may be provided on the object capable of moving, By way of example only, a companion computer may communicate with and/or control an autopilot. An autopilot may be a flight controller. Where the companion computer is provided on a drone, the companion computer may receive data produced by the autopilot or flight controller. This data may be telemetry related data. For example, the data may comprise GPS data. The data may be used by the companion computer to make decisions during flight. A companion computer may provide computer mediated flight paths, vision processing, and/or one or more other functions.

Alternatively or additionally, the first apparatus may be any suitable apparatus which requires information about the object which is capable of moving.

It should be appreciated that in some embodiments the second apparatus may communicate with a single first apparatus. In some embodiments, the second apparatus may communicate with more than one first apparatus. For example, the second apparatus may communicate with a control station and with a companion computer.

In some example embodiments, the object which is capable of moving is a UAV or a drone. The drone may be controlled by a ground control station GCS. For example, the drone may be controlled by a computer program or software running on at least one processor of the ground control station. In this disclosure, the computer program or software running on at least one processor of the ground control station is referred to as ground control station software (GCSS).

The ground control station may be on the ground and remote from the drone.

The ground control station may determine what a drone is doing by interpreting data provided in messages sent by the drone and received by the ground control station. The data may be telemetry related data.

In some embodiments, the UAV or drone may be controlled by software on the drone itself.

Some embodiments may aim to improve communication between the object capable of moving and the first apparatus.

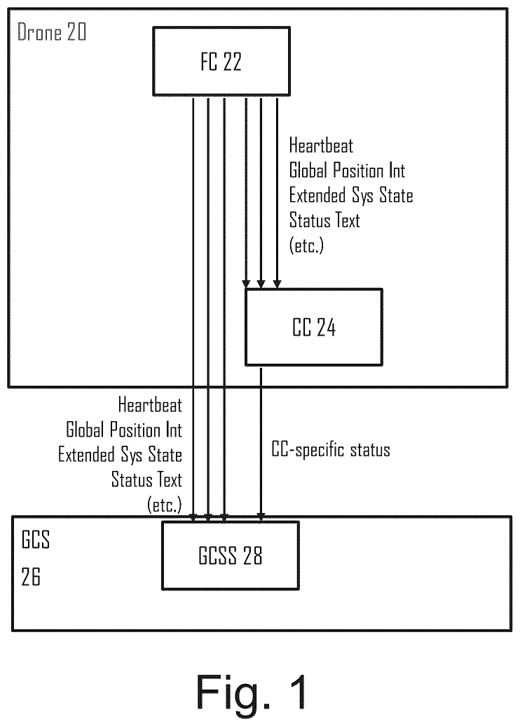

An example of an arrangement will now be described with reference to FIG. 1. A drone 20 has a flight controller (FC) 22 and a companion computer (CC) 24. A ground control station GCS 26 is provided with ground control station software GCSS 28. The flight controller FC 22 communicates with the ground control station GCS 26. The flight controller FC 22 also communicates with the companion computer CC 24. The companion computer CC 24 communicates with the ground control station GCS 26.

The flight controller FC communicates its data, for example telemetry related data. The data may be sent to the companion computer CC and/or the ground control station GCS. By way of example the data may comprise one or more of heartbeat data, global position data, orientation of the drone, speed of the drone, extended system status, status text, error data, ongoing mission data, and/or the like.

The data may be communicated from the FCC using Micro Air Vehicle Link (MAVLink) messages or messages in accordance with any other suitable protocol. The MAVLink messages may be received by the companion computer CC and/or the ground control station GCS.

MAVLink is an open source, point-to-point communication protocol used between a ground control station and unmanned vehicles (e.g. drone) to carry data such as telemetry related data, and to command and control unmanned vehicles. MAVLink may be used for example, to transmit the orientation of an unmanned vehicle, the GPS location of the unmanned vehicle, and the speed of the unmanned vehicle.

The recipient of the data, for example the ground control station (GCS) and/or the onboard companion computer (CC) each need to process the data in order to determine the status of the drone.

If another application requires information about the status of the drone, the messages would be forwarded to that application for processing by that application.

The data sent using MAVLink messages is sent as individual primitive datatype values (for example as Boolean flags, enumerated types, integers, floating point numbers, and/or the like). These values are further split into different message types.

To understand what the drone is doing, the application using the data such as the telemetry related data may need to know which of the MAVLink messages are of relevance. The application using the telemetry may need to know which of the individual data fields across the various MAVLink messages are related to each other.

Consider an example where the heartbeat message reports the system status with an enumerated type, which indicates “System is active and might be already airborne. Motors are engaged”. To know if the drone is flying or not, other fields need to be looked at to determine if the drone is armed, what the current flight mode is, and what the current altitude is relative to the arming location. The information which is required to determine a status of the drone, such as in the example discussed is scattered throughout the telemetry related data and provided in different messages.

Another issue relates to the implementation of the MAVLink protocol. There can be some variation in the how the messages are structured and what telemetry is provided in the MAVLink messages depending on the version of the MAVLink protocol used and/or how the MAVLink protocol has been implemented. This may mean that, for example, a ground control station may have to deal with MAVLink messages for a number of different of drones which are structured in a number of different ways. This may be an issue for the ground control station.

Some embodiments may structure the information provided by the telemetry related data. This structuring may be carried out by the second apparatus. The second apparatus may receive the telemetry related data in MAVLink messages or in messages in accordance with any other suitable protocol or format. The information provided by the telemetry related data in the MAVLink messages may be processed by the second apparatus to provide data about the drone. The second apparatus may provide the data about the drone in a in a format which may improve communication efficiency between the drone and the first apparatus (e.g. the ground control station and/or the companion computer). As the second apparatus processes the telemetry related data and provides the data about the drone, the need for each first apparatus to be able to process a number of variations in the MAVLink messages may be avoided. This may reduce or avoid errors which might otherwise arise if the first apparatus was to process the telemetry.

In some embodiments, the second apparatus receives the telemetry related data. In some embodiments, the second apparatus may determine a current status of the object which is capable of moving.

In some embodiments, a message about the current status, of the object which is capable of moving, is sent by the second apparatus to the first apparatus. The first apparatus may be any of the examples of first apparatus previously described.

A current status of the object may be associated with a hierarchical organization.

For example, the object which is capable of moving may have one of a set of mutually exclusive states. Optionally, one or more of the states may comprise one or more mutually exclusive sub-states. One or more substates may be associated with one or more state-specific properties. One or more of the state-specific properties may be mutually exclusive. One or more of the state-specific properties may not be mutually exclusive.

In some embodiments, one or more sub states may be associated with one or more further substates.

In some embodiments, the telemetry related data is used by the second apparatus to determine a status of the of the object which is capable of moving. The second apparatus may send a message which comprises information about a status of the object which is capable of moving.

The second apparatus may in some embodiments be provided as part of the object capable of moving. In other embodiments, the second apparatus may be provided at a location which is different to that of the object which is capable of moving.

In some embodiments, the second apparatus is arranged to send a further message in response to the second apparatus determining that there is a change in the status the object. In some embodiments, the further message is only sent if there is a change in the status of the object. This may reduce the number of messages which need to be sent to the first apparatus.

A status of an object may change if there is a change in one or more of a state, a substate; or a state specific property.

This may avoid the need for the telemetry to be sent to the first apparatus. This may have the advantage in reducing the required communication resources. This may have the advantage that the first apparatus does not need to understand or process the telemetry related data.

In some embodiments, the message may be sent by the second apparatus using a protocol for serializing structured data. One example of such a protocol is Protocol Buffers (Protobuf). With Protobuf, an interface description language describes the structure of data, and a program generates source code from that description for generating or parsing a stream of bytes that represents the structured data. Other examples of protocols are Apache Thrift, Ion, and Microsoft Bond protocols.

In some embodiments, Protobuf is used to define the messages to represent a current status of the object which is capable of moving. In other embodiments, a different protocol to Protobuf may be used.

Protobuf supports a feature which is referred to in the Protobuf protocol as Oneof. This Oneof feature can be used with messages with many singular fields and where at most one field will be set at the same time. Oneof fields may be considered to be optional fields except all the fields in a Oneof structure share memory. At most one field can be set at the same time. Setting any member of the Oneof fields automatically clears all the other members.

In some embodiments, a different protocol supporting a similar feature to the Oneof features may be used.

The Oneof feature of Protobuf may be used with the mutually exclusive states and any state-specific information fields to share memory. This means hat the message size can be relatively small. This may save bandwidth.

The message may be sent via a secure channel. The channel may be a gRPC (this is a remote procedure call channel associated with Protobuf).

gRPC supports end-to-end encryption. This is in contrast to MAVLink which supports message signing but not end to end encryption.

The message may be sent by the second apparatus to the first apparatus using a protocol which is requires an acknowledgement. This acknowledgement may be from, for example, the first apparatus. The second apparatus will resend any message which is not acknowledged, for example by the first apparatus. By way of example, the message may be sent using the TCP (transmission control protocol) which requires acknowledgement of messages and messages which are not acknowledged are retransmitted. The gRPC protocol is one option which can be used here as it is built on TCP. This is in contrast to MAVLink which sends messages periodically over UDP.

By sending a message to the first apparatus only if the status of a drone changes, the need to send many different messages with telemetry from, for example, flight controller to the one or more first apparatus may be avoided. This may reduce the number of resources required to transmit the messages.

It should be appreciated that the messages sent form the second apparatus to the first apparatus may be sent via a wired connection and/or a wireless connection. By way of example, the messages sent by the second apparatus to the ground control station may be via a wireless connection. The messages sent by the second apparatus to the companion computer may be sent via a wired connection and/or via a wireless connection.

In some embodiments, the message which is sent by the second apparatus may provide information potentially relating to telemetry related data which may be considered to be of more importance.

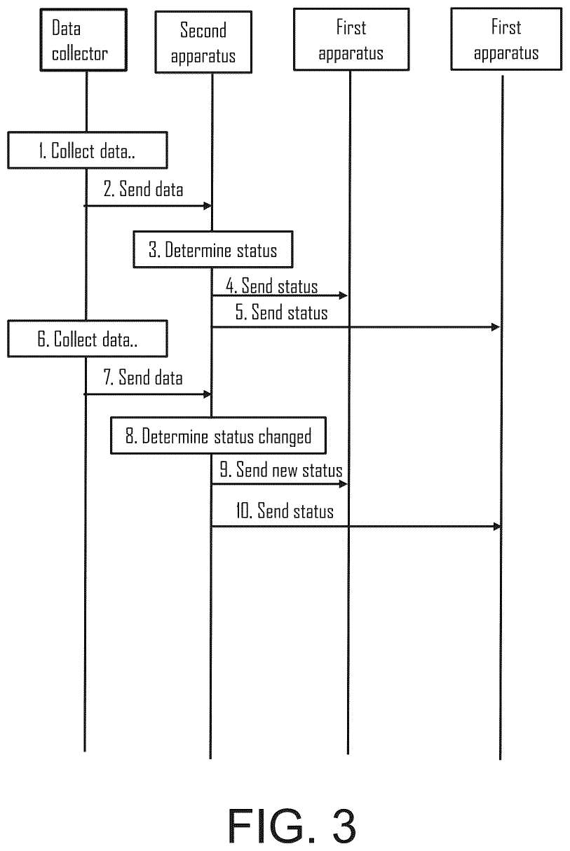

Reference is made to FIG. 3 which shows an embodiment. In this example, the object which is capable of moving is a drone 20.

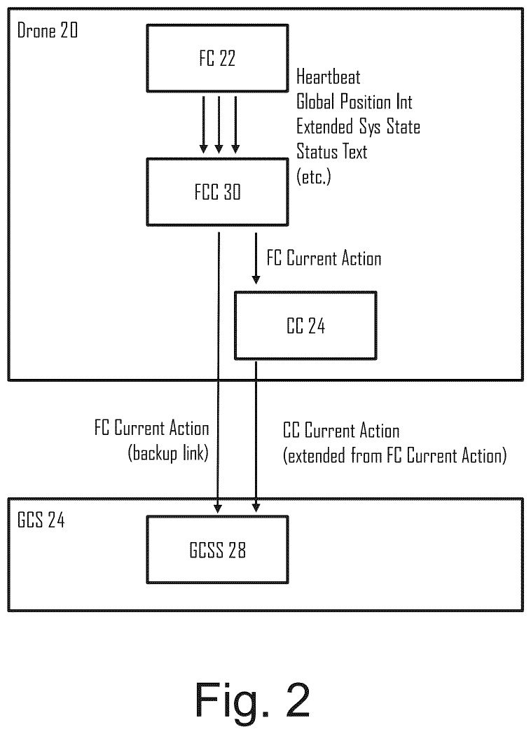

In the example of FIG. 3, the second apparatus is referred as a flight controller communicator (FCC) 30. The flight controller communicator or second apparatus receives the data from the flight controller 22. This data may be telemetry related data. The flight controller communicator or second apparatus processes the data to provide information about a current status of the drone. The current status of the drone may be referred to the drone current action in this disclosure. As the flight controller communicator or second apparatus processes the data to provide the drone current action, this means other parts of the system do not have to do that processing. In the example of FIG. 1, the ground station and the companion computer both needed to receive and process the data. In contrast, in the embodiment shown in FIG. 2, the companion computer 24 and/or the ground control station receive information about the current status of the drone. The companion computer 24 and/or the ground control station would not need to process the data in order to determine the current status of the drone. This may avoid the need for the data to be provided to companion computer 24 and/or the ground control. For example, this may avoid the need for the companion computer 24 and/or the ground control to receive MAVLink messages with the data.

Some embodiments may reduce the use of communication resources as compared to the example of FIG. 1. This may improve bandwidth usage as compared to the example of FIG. 1. In some embodiments, by not having to send the data such as telemetry related data to for example the ground control station, reliability and/or security of the communication of information may be improved.

In some embodiments, the message provided by the second apparatus may comprise in a single message a current status of the drone. In contrast, the arrangement of FIG. 1 would require the first apparatus to receive several MAVLink messages in order to be able to determine the current status of the drone.

The need for processing of the data, for example the telemetry related data to determine a current status by different components, such as the companion computer and the ground control station may be avoided.

In some embodiments, the onboard companion computer CC 24 may receive the drone current action from the flight controller communicator or second apparatus.

The onboard companion computer may receive the messages from the flight controller communicator FCC 30 and add information to that message. In other embodiments, the flight controller communicator FCC 30 may provide a message which comprises information about the status of the drone which the CC 24 received from the flight controller communicator FCC 30 and information provided by the CC 24 itself.

In some embodiments, an apparatus such as the ground control station may receive a message from the companion computer. This message from the companion computer will not only provide the information that the companion computer itself is providing but also the current status of the drone. This may be advantageous in that communications may be simpler and/or more efficient because the full status of the drone and the information which the companion computer needs to provide are provided together.

In FIG. 3, FC Current Action represents the current status of the drone and is determined by the second apparatus using flight controller data such as telemetry related data. The data from the flight controller may be provided by the FCC component.

In FIG. 3, CC Current Action represents the current status of the drone as determined by the second apparatus and the companion computer specific information (e.g. for action sequences that are implemented on the companion computer side, such as landing in a docking station).

This means that a ground control station can receive the entire drone status directly from the companion computer. Furthermore, in the case of malfunction or failure on the companion computer side, the ground control station can fall back to requesting the current drone status directly from the second apparatus.

In some embodiments, there may be redundancy in that the current status of the drone may be provided to the ground control station by both the second apparatus and the companion computer. The system may be robust because in the event of onboard companion computer failure, the ground control station may still receive the messages with the current drone status from the second apparatus.

Determining a current status of a drone may require domain-specific knowledge about the possible states of the drone, actions of the drone, sensor outputs, and/or telemetry related messages of the drone.

A drone current action or the current status of the drone may be understood to be the information that is needed to define and summarize what the drone is currently doing.

A drone current action or status may be defined by mutually exclusive states that may contain their own mutually exclusive sub-states.

One example of a message structure used by some embodiments is provided below.

A single message may be defined for communicating the overall state of the object. The object may be in one of a plurality of different and mutually exclusive states at a given time. The exclusive states are such that that the object can only be in one of those exclusive states at a given time. The object cannot be in two of the exclusive states at the same time.

In some embodiments, one or more of the states may be associated with one or more substates. One or more substates may be associated with one or more properties. One or more substates may not be associated with substates.

This may be represented by following format:

### [State]

a. [substate 1]
b. [substate 2]
   i. Property 1
   ii. Property 2

For example, at a first or high level, the drone can be in one of three states:
a. Landed—that is the drone is on the ground
b. Flying—that is flying in the air
c. Crashing

In one embodiment, the drone current action is defined as a set of three mutually exclusive states: flying/landed/crashing. In this example, the drone will always be in one of these states.

It should be appreciated that in other embodiments there may be more than three states or less than three states.

It should be appreciated that in other embodiments, there may be one or more different states to the examples provided above.

The states which are available for the object capable of moving may depend on the particular object.

In some embodiments, the telemetry is used by the flight controller communicator FCC or other apparatus to determine which of the plurality of different and exclusive states is the current state of the object. The data, for example telemetry related data may be provided by MAVLink messages or any other t messages.

For example, the flight controller communicator FCC or other apparatus may determine if the drone is in the air based on both:
a. Heartbeat ‘system status’ enumeration (this may indicate the motors are engaged); and.
b. Based on global position relative altitude to arming location (this may indicate the height of the drone with respect to the ground).
   The heartbeat message shows that a system or component is present and responding. The type and autopilot fields (along with the message component id), allow the receiving system to treat further messages from this system appropriately (e.g. by laying out the user interface based on the autopilot).
   Some examples of heartbeat message fields of MA VLink messages is shown below.

| Field Name | Type | Values | Description |
|---|---|---|---|
| type | uint8_t | MAV_TYPE | Vehicle or component type. For a |
| | | | flight controller component the |
| | | | vehicle type (quadrotor, helicopter, |
| | | | etc.). For other components the |
| | | | component type (e.g. camera, gimbal, |
| | | | etc.). This should be used in |
| | | | preference to component id for |
| | | | identifying the component type. |
| autopilot | uint8_t | MAV_AUTOPILOT | Autopilot type/class. |
| | | | Use MAV AUTOPILOT INVALID |
| | | | for components that are not flight |
| | | | controllers. |
| base_mode | uint8_t | MAV_MODE_FLAG | System mode bitmap. |
| custom_mode | uint32_t | | A bitfield for use for autopilot- |
| | | | specific flags |
| system_status | uint8_t | MAV_STATE | System status flag. |
| mavlink_version | uint8_t_mavlink_{—} | | MAVLink version, not writable by |
| | version | | user, gets added by protocol because |
| | | | of magic data type: |
| | | | uint8_t_mavlink_version |

The system state, referred to as MAV_STATE may have the following options.

| Value | Name | Description |
|---|---|---|
| 0 | MAV_STATE_UNINIT | Uninitialized system, state is unknown. |
| 1 | MAV_STATE_BOOT | System is booting up. |
| 2 | MAV_STATE_CALIBRATING | System is calibrating and not flight-ready. |
| 3 | MAV_STATE_STANDBY | System is grounded and on standby. It can be launched |
| | | any time. |
| 4 | MAV_STATE_ACTIVE | System is active and might be already airborne. |
| | | Motors are engaged. |
| 5 | MAV_STATE_CRITICAL | System is in a non-normal flight mode (failsafe). It can |
| | | however still navigate. |
| 6 | MAV_STATE_EMERGENCY | System is in a non-normal flight mode (failsafe). It |
| | | lost control over parts or over the whole airframe. It is |
| | | in mayday and going down. |
| 7 | MAV_STATE_POWEROFF | System just initialized its power-down sequence, will |
| | | shut down now. |
| 8 | MAV_STATE_FLIGHT_{—} | System is terminating itself (failsafe or commanded). |
| | TERMINATION | |

The table below shows the flags which are used to encode the MAV mode.

| Value | Name | Description |
|---|---|---|
| 1 | MAV_MODE_FLAG_CUSTOM_{—} | 0b00000001 Reserved for future use. |
| | MODE_ENABLED | |
| 2 | MAV_MODE_FLAG_TEST_{—} | 0b00000010 system has a test mode enabled. |
| | ENABLED | This flag is intended for temporary system |
| | | tests and should not be used for stable |
| | | implementations. |
| 4 | MAV_MODE_FLAG_AUTO_{—} | 0b00000100 autonomous mode enabled, |
| | ENABLED | system finds its own goal positions. Guided |
| | | flag can be set or not, depends on the actual |
| | | implementation. |
| 8 | MAV_MODE_FLAG_GUIDED_{—} | 0b00001000 guided mode enabled, system |
| | ENABLED | flies waypoints/mission items. |
| 16 | MAV_MODE_FLAG_{—} | 0b00010000 system stabilizes electronically |
| | STABILIZE_ENABLED | its attitude (and optionally position). It needs |
| | | however further control inputs to move |
| | | around. |
| 32 | MAV_MODE_FLAG_HIL_{—} | 0b00100000 hardware in the loop |
| | ENABLED | simulation. All motors/actuators are |
| | | blocked, but internal software is full |
| | | operational. |
| 64 | MAV_MODE_FLAG_MANUAL_{—} | 0b01000000 remote control input is enabled. |
| | INPUT_ENABLED | |
| 128 | MAV_MODE_FLAG_{—} | 0b10000000 MAV safety set to armed. |
| | SAFETY_ARMED | Motors are enabled/running/can start. |
| | | Ready to fly. Additional note: this flag is to |
| | | be ignore when sent in the |
| | | command MAV_CMD_DO_SET_MODE and |
| | | MAV_CMD_COMPONENT_ARM_DISARM |
| | | shall be used instead. The flag can still |
| | | be used to report the armed state. |

In some embodiments, the flight controller communicator FCC or other apparatus may determine if the drone is armed based on a heartbeat ‘base mode’ bitfield. The MAVLink heartbeat ‘base_mode’ may comprise several fields. Each field contains a value or flag which indicates if the state or condition present in a field is present or not. The flag may be regarded as either being on or off

In some embodiments, the flight controller communicator FCC or other apparatus may consider the drone as:
In the landed state if not in the air.
In the flying state if in the air and armed.
In the crashing state if in the air and disarmed.

The armed/disarmed status is a safety feature on some autonomous vehicles. Before a drone can fly, the pilot gives an ‘arm’ command to arm a disarmed drone.

When a drone is disarmed, the motors may not spin, the drone may not take off or fly, and/or the drone is safe to approach and be handled by a person.

When a drone is armed, the motors may spin, the drone may take off and fly, and/or the drone is not safe for people to approach.

A flag or indication that the drone is armed or not may be used. For example the MAV_MODE_FLAG_SAFETY_ARMED may be used. This flag when set, indicates if the drone is armed or not.

If drone reports a high altitude and the drone is armed, the drone is in the flying state

If drone reports high altitude and the drone is disarmed, the drone is in the crashing state

If drone reports ground level altitude and the drone is disarmed, the drone is in the grounded state

If drone reports ground level altitude and it is armed, the drone is in the grounded state and ready to take off.

It should be appreciated that the determination of a particular state of the object may be based on one or more different conditions or properties as compared to the examples shown.

Consider the following example.

The state is a landed state. The substates may be armed and disarmed. The disarmed substate may be as associated with a property indicating a ready to arm property. This may be indicated by a flag, such as a Boolean flag. The disarmed substate may be as associated with a property indicating a pre-arm error or errors. The pre-arm error or errors may be indicated by a list of strings.
1. [Landed]
   a. [Armed]
   b. [Disarmed]
      i. Boolean flag ‘Ready to arm’
      ii. List of strings ‘pre-arm errors’
   2 [Flying]
   3. [Crashing]

In this example, the states are mutually exclusive. For example, if the drone is ‘Landed’, it cannot be ‘Flying’ or ‘Crashing’.

In this example, the substates are mutually exclusive. For example, if a ‘Landed’ drone is ‘Armed’, the drone cannot be ‘Disarmed’.

This format allows for more efficient communications.

It may be easy to write logic based on the states for visualization.

When drawing the drone on the map, different visualization logic or assets may be used based on the current state and its sub-states.

In some embodiments, the information provided about the status of the object, for example the drone, may be used by at least one processor to control a user interface for the drone. The user interface may be provided in the ground station or in a different location. The user interface for the drone may be used to control the drone. The user interface may have one or more options or buttons to control the drone.

In some embodiments, the at least one processor controls the user interface based on the current drone status.

In some embodiments, information about one or more of the current state, a current substate, or a property of a substate may be used to determine if an option is presented or enabled.

In some embodiments, information about one or more of the current state, a current substate, or a property of a substate may be used to determine if an option is not presented or not enabled.

For example, a land drone option may not be presented or may be disabled if the drone is not in the flying state.

For example, the arm drone option may not be presented or may be disabled if the drone is not in landed state, if the drone is in the landed state and the sub-state is armed, or if the drone is in the is in the landed state and the sub-state is disarmed and the Boolean flag for ready to arm is false. In any other case, the arm drone option may be presented or may be enabled.

For example, the disarm drone option may not be presented or may be disabled if the drone is not in the landed state, or if the drone is in the landed state and the landed substate is armed.

Structuring of the data as discussed previously supports logic which uses guard clauses. In computer programming, a guard is a Boolean expression that evaluates to true if the execution of the program is to continue in the branch in question.

Another example of the states, substates, and properties for a drone will now be explained. In this example, the states are again flying, crashing, landing:
1. State—Landed
   a. Substate—Armed
      i. Property—time until automatic disarm
   b. Substate—disarmed
      i. Property—Boolean flag ‘Ready to arm’
      ii. Property—list of strings ‘pre-arm errors’
2. State—Flying
   a. Substate—Standby Hover
   b. Substate—Manual Flight
   c. Substate—Guided Flight
      i. Property Navigation command
   d. Substate—Mission Flight
      i. Property—Current mission type
      ii. Property—Current index in ongoing mission
      iii. Property—Current navigation command
   e. Substate—Docking Station Landing
      i. Property Docking station ID
      ii. Property—Landing state
3. State—Crashing
   a. Substate—Crash location
   b. Substate—Crash reason

In this example, some of the substates have no properties. For example, the standby hover substate has no properties as it is used to indicate that the drone is hovering in place waiting for next command.

In this example, some of the substates have properties. For example, the mission flight substate has properties that detail the progression through the current flight mission. The properties are current mission type, current index in ongoing mission, and current navigation command.

In some embodiments, the second apparatus may be an adaptor. The adapter may he provided between the drone and the rest of drone network related entities. The network related entities may be a ground control station, an onboard companion computer, and/or one or more APIs (application programming interfaces). One or more of the network related entities may be running a computer program.

The examples discussed previously have used drones. Other embodiments may be used with any type of autonomous vehicles or other objects, where the current state or action of the object can be divided into mutually exclusive states.

In some embodiments, the second apparatus provides a current status of the drone based on the telemetry related data. In some embodiments, information unrelated to the status of the object may be communicated in separate messages (e.g. battery or connectivity status).

Reference is made to FIG. 3 which shows a procedure according to some embodiments.

As referenced 1, an apparatus collects data. The apparatus is referred to as a data collector in FIG. 3. The data collector may be the FC shown in FIG. 2.

As referenced 2, the data collector sends messages to the second apparatus in messages. These messages may be sent when there is data to be reported. The messages maybe MAVLink messages or other messages. These messages may be as previously described.

As referenced 3, the second apparatus will determine the current status of the object, for example a drone. The current status may be defined by one or more of the current state, the current substate, and the current property. The second apparatus may be the FCC or any other suitable apparatus as previously described.

As referenced 4 and 5, the second apparatus will send a message to one or more first apparatus with the determined status of the object. In this example, the second apparatus provides the status to two first apparatus. The first apparatus may be as previously described. The first apparatus may be a companion computer and/or a ground control station.

As referenced 6 and 7, the data collector is continuing to collect data and send messages with the data to the second apparatus.

As referenced 8, the second apparatus will use the received data to determine if there is a change in a current status of the object. For example, one or more of the state, the substate, and/or the property may change.

As referenced 9 and 10, if there is a change in a current status, the second apparatus will send a message to the one or more first apparatus with updated status.

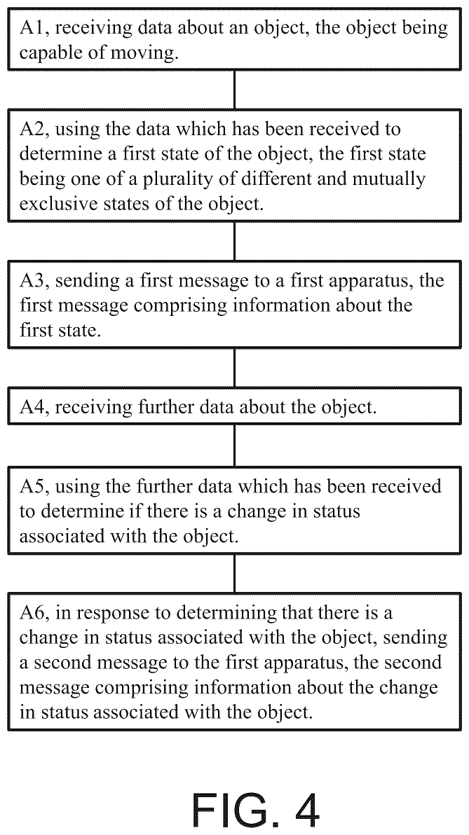

Reference is made to FIG. 4 which shows some methods of some example embodiments.

The respective methods may be performed by an apparatus.

The apparatus may comprise suitable means, such as circuitry for providing the method.

Alternatively or additionally, the apparatus may comprise at least one processor and at least one memory storing instructions that, when executed by the at least one processor, cause the apparatus at least to provide the method below.

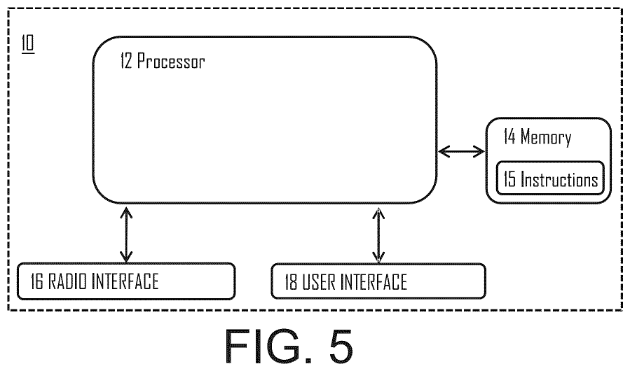

Alternatively or additionally, the apparatus may be discussed in relation to FIG. 5

The respective methods may be provided by computer program code or computer executable instructions.

One or more of the methods may be modified to one include one or more steps such as previously described.

Reference is made to FIG. 4. The apparatus may be a second apparatus.

Alternatively the method may be performed by an apparatus in an object which is capable of moving.

The method may comprise as referenced A1, receiving data about an object, the object being capable of moving.

The method may comprise as referenced A2, using the data which has been received to determine a first state of the object, the first state being one of a plurality of different and mutually exclusive states of the object.

The method may comprise as referenced A3, sending a first message to a first apparatus, the first message comprising information about the first state.

The method may comprise as referenced A4, receiving further data about the object.

The method may comprise as referenced A5, using the further data which has been received to determine if there is a change in status associated with the object.

The method may comprise as referenced A6, in response to determining that there is a change in status associated with the object, sending a second message to the first apparatus, the second message comprising information about the change in status associated with the object.

The method as shown in FIG. 4 may be modified to include any of the previously discussed features.

FIG. 5 shows, by way of example, a block diagram of an apparatus 10. The apparatus 10 comprises, for example, at least one processor 12 and at least one memory 14 storing instructions 15 that, when executed by the at least one processor, cause the apparatus 10 at least to perform the method or methods as disclosed herein, and any of the embodiments thereof. In an example, the at least one memory and the instructions (e.g. a computer program code, software), are configured, with the at least one processor, to cause the apparatus 10 to perform the method or methods as disclosed herein, and any of the embodiments thereof.

A processor 12 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer readable medium or a non-transitory computer readable medium. A term non-transitory, as used herein, is a limitation of the medium itself (i.e. tangible, not a signal) as opposed to a limitation on data storage persistency (e.g. random-access memory, RAM, vs. read only memory, ROM).

The apparatus may be or comprise the second apparatus. For example, the apparatus 10 may be provided in the object capable of moving or be the object capable of moving. As another example, the apparatus is comprised for example as a chipset. As another example, the apparatus may be remotely located with respect to the object capable of moving. The apparatus 10 may be caused or configured to perform at least the method of FIG. 5 and/or any one or more of the embodiments described.

The apparatus may be or comprise the first apparatus. As another example, the apparatus 10 may be provided in a ground control station or another entity which has an application which uses data about the object capable of moving. The apparatus may be a ground control station or another entity which has an application which uses data about the moving. As another example, the apparatus 10 may be provided in the object capable of moving or be the object capable of moving. The apparatus may comprise a chipset.

The apparatus 10 may optionally comprise a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

In some embodiments, the apparatus may be provided with an interface for communication with one or more other apparatus.

The apparatus 10 may optionally comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In an embodiment, at least some of the processes described herein may be carried out by an apparatus comprising means for carrying out at least some of the described processes. Means for performing method steps as disclosed herein may include software and/or hardware components of the apparatus 10. For example, the at least one processor 12, the memory 14, and the computer program code form means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the invention has been described above with reference to an example according to the accompanying drawings, it is clear that the invention is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A second apparatus comprising at least one processor; and at least one memory storing instructions that, when executed by the at least one processor, cause the apparatus at least to:
receive data about an unmanned vehicle;
use the data which has been received to determine a first state of the unmanned vehicle, the first state being one of a plurality of different and mutually exclusive states of the unmanned vehicle;
send a first message to a first apparatus, the first message comprising information about the first state;
receive further data about the unmanned vehicle,
use the further data which has been received to determine if there is a change in status associated with the unmanned vehicle, and
in response to determining that there is a change in status associated with the unmanned vehicle, send a second message to the first apparatus, the second message comprising information about the change in status associated with the unmanned vehicle.

2. The second apparatus as claimed in claim 1, wherein one of more of the plurality of different and exclusive states comprise one or more mutually exclusive substates.

3. The second apparatus as claimed in claim 1, wherein the change in status associated with the unmanned vehicle comprises one or more of:
a change from one of the plurality of different and mutually exclusive states to another one of the plurality of different and exclusive states; or
a change from one of a plurality of different and mutually exclusive substates to another one of the plurality of different and mutually exclusive substates.

4. The second apparatus as claimed in claim 1, wherein one or more of the first message or the second message uses a message format comprising a plurality of fields where only one of said fields is set at a given time, different ones of said fields being associated with a different status of the unmanned vehicle.

5. The second apparatus as claimed in claim 4, wherein the message format uses a protocol buffer data format.

6. The second apparatus as claimed in claim 1, wherein the apparatus is further caused to send the first and second messages to the first apparatus using an acknowledgement based protocol, such that if a respective acknowledgement is not received, the respective message is resent.

7. The second apparatus as claimed in claim 6, wherein the acknowledgement based protocol comprises transmission control protocol.

8. The second apparatus as claimed in claim 1, where the unmanned vehicle comprises one of: a land vehicle; an autonomous vehicle; an airborne vehicle, a robot; or a drone.

9. The second apparatus as claimed in claim 8, wherein the unmanned vehicle comprises a drone and the first apparatus comprises one or more of a ground control station or a companion computing apparatus on the drone.

10. The second apparatus as claimed in claim 8, wherein one or more of the received data or the further received data comprises one or more of:
system status data; heartbeat data; error data; ongoing mission data; or position data.

11. The second apparatus as claimed in claim 9, wherein the plurality of different and mutually exclusive states comprise one or more of:
landed; flying; or crash.

12. An unmanned vehicle, said unmanned vehicle comprising the second apparatus as claimed in claim 1.

13. The unmanned vehicle as claimed in claim 12, comprising a companion computing apparatus is configured to use the information from one or more of the first and second messages to provide one or more third messages for sending to a control station.

14. The unmanned vehicle as claimed in claim 13, wherein the one or more of the third messages comprise data relating to one or more sensors carried by the unmanned vehicle and the information provided by a respective one of the first and second messages.

15. A method comprising:
receiving data about an unmanned vehicle;
using the data which has been received to determine a first state of the unmanned vehicle, the first state being one of a plurality of different and mutually exclusive states of the unmanned vehicle;
sending a first message to a first apparatus, the first message comprising information about the first state;
receiving further data about the unmanned vehicle;
using the further data which has been received to determine if there is a change in status associated with the unmanned vehicle; and
in response to determining that there is a change in status associated with the unmanned vehicle, sending a second message to the first apparatus, the second message comprising information about the change in status associated with the unmanned vehicle.

16. A non-transitory computer readable medium comprising computer executable instructions which when run on at least one processor cause:
receiving data about an unmanned vehicle;
using the data which has been received to determine a first state of the unmanned vehicle, the first state being one of a plurality of different and mutually exclusive states of the unmanned vehicle;
sending a first message to a first apparatus, the first message comprising information about the first state;
receiving further data about the unmanned vehicle;
using the further data which has been received to determine if there is a change in status associated with the unmanned vehicle; and
in response to determining that there is a change in status associated with the unmanned vehicle, sending a second message to the first apparatus, the second message comprising information about the change in status associated with the unmanned vehicle.
